(19) United States
(12) Patent Application Publication
(10) Pub. No.: US 2025/0163080 A1
(43) Pub. Date: May 22, 2025

(54) METAL ORGANIC FRAMEWORK AND METHOD FOR PRODUCING THE SAME

(71) Applicant: TOYOTA JIDOSHA KABUSHIKI KAISHA, Toyota-shi (JP)

(72) Inventors: Yoshio OHASHI, Gotemba-shi (JP); Takuro Yokoya, Zama-shi (JP)

(73) Assignee: TOYOTA JIDOSHA KABUSHIKI KAISHA, Toyota-shi (JP)

(21) Appl. No.: 18/948,705

(22) Filed: Nov. 15, 2024

(30) Foreign Application Priority Data
Nov. 22, 2023 (JP) 2023-198386

(51) Int. Cl. C07F 3/06; B01J 20/22; B01J 20/30

(52) U.S. Cl. CPC C07F 3/06; B01J 20/226; B01J 20/3021; B01J 20/3085

(57) ABSTRACT

The present disclosure provides means for producing a MOF having an RHO-type topology with a high gas adsorption property in high yields. One aspect of the present disclosure relates to a metal organic framework containing metal ions as zinc cations and ligands as 2-ethylimidazole (2-EtIm) or monocarboxylic acid anions. The metal organic framework has an RHO-type topology in which the 2-EtIm anions are partially substituted with the monocarboxylic acid anions. Another aspect of the disclosure relates to a method for producing the metal organic framework having the above-described features.

### CROSS REFERENCE TO RELATED APPLICATIONS

The present application claims priority from Japanese patent application JP 2023-198386 filed on Nov. 22, 2023, the entire content of which is hereby incorporated by reference into this application.

### BACKGROUND

### Technical Field

The present disclosure relates to a metal organic framework and a method for producing the same.

### Background Art

A metal organic framework (hereinafter, also referred to as “MOF”) is a crystalline porous material made of metal and organic ligands. Depending on the combination of the metal and the organic ligands used, the properties such as pore size and surface profile of MOFs can be designed at the molecular level. MOFs are expected to be applied to, for example, a gas storage material, a heterogenous catalyst, and a conductive material, and the like.

For example, P. J. Beldon et al., Angew. Chem. Int. Ed. vol. 49, p. 9640-9643 (2010) discloses a method for synthesizing a MOF of Zn(2-EtIm)₂ that is made of metal ions as zinc cations and ligands as 2-ethylimidazole (2-EtIm) anions and has an RHO-type topology, by a mechanochemical reaction.

### SUMMARY

As mentioned above, the method for producing the MOF of Zn(2-EtIm)₂ having the RHO-type topology by the mechanochemical reaction is known. However, in the conventional method, there has been a problem of low yield due to the low solubility of a zinc compound as a raw material in organic solvents. In addition, there has been room for improvement in a gas adsorption property of the MOF produced by the conventional method.

Therefore, the present disclosure provides means for producing a MOF having the RHO-type topology with a high gas adsorption property in high yields.

The inventors have studied various means for solving the above problems. The inventors have found that, in production of the MOF by a mechanochemical reaction, adding a monocarboxylic acid to the zinc compound and 2-ethylimidazole, which are raw materials, allows the MOF having the RHO-type topology with a structure in which 2-ethylimidazoles are partially substituted with the monocarboxylic acids to be obtained in high yields. Based on the above findings, the inventors have completed the present disclosure.

That is, the present disclosure encompasses the following aspects and embodiments.
(Embodiment 1) A metal organic framework comprises metal ions as zinc cations and ligands as 2-ethylimidazole (2-EtIm) or monocarboxylic acid anions. The metal organic framework has an RHO-type topology in which the 2-EtIm anions are partially substituted with the monocarboxylic acid anions.
(Embodiment 2) In the metal organic framework according to the embodiment 1, the monocarboxylic acid is benzoic acid or acetic acid.
(Embodiment 3) In the metal organic framework according to the embodiment 1 or 2, an abundance ratio of the monocarboxylic acid anions in the ligands to a total amount by mole of the ligands is in a range from 1 to 20 mol %.
(Embodiment 4) A method for producing the metal organic framework according to any of the embodiments 1 to 3 comprises causing a mechanochemical reaction between a zinc compound, 2-ethylimidazole (2-EtIm), and a monocarboxylic acid in a presence of a solvent.
(Embodiment 5) In the method according to the embodiment 4, the mechanochemical reaction includes mixing raw materials using a ball mill.

The present disclosure can provide means for producing a MOF having an RHO-type topology with a high gas adsorption property in high yields.

### BRIEF DESCRIPTION OF THE DRAWINGS

FIG. 1 illustrates an X-ray diffraction pattern of a product powder of Example 1. The horizontal axis indicates a 2θ value (°), and the vertical axis indicates intensity (a.u.). 100 rpm, 200 rpm, 300 rpm, 400 rpm, or 500 rpm indicates a rotation speed of a planetary ball mill apparatus during production. RHO-type, ANA-type, or ZnO indicates a simulation result of an X-ray diffraction pattern of RHO-type Zn(2-EtIm)₂, ANA-type Zn(2-EtIm)₂, or ZnO by calculation;

FIG. 2 illustrates an X-ray diffraction pattern of a product powder of Example 2. The horizontal axis indicates a 2θ value (°), and the vertical axis indicates intensity (a.u.). 100 rpm, 200 rpm, 300 rpm, 400 rpm, or 500 rpm indicates the rotation speed of the planetary ball mill apparatus during production. RHO-type, ANA-type, or ZnO indicates a simulation result of an X-ray diffraction pattern of RHO-type Zn(2-EtIm)₂, ANA-type Zn(2-EtIm)₂, or ZnO by calculation;

FIG. 3 illustrates an X-ray diffraction pattern of a product powder of Example 3. The horizontal axis indicates a 2θ value (°), and the vertical axis indicates intensity (a.u.). 100 rpm, 200 rpm, 300 rpm, 400 rpm, or 500 rpm indicates the rotation speed of the planetary ball mill apparatus during production. RHO-type, ANA-type, or ZnO indicates a simulation result of an X-ray diffraction pattern of RHO-type Zn(2-EtIm)₂, ANA-type Zn(2-EtIm)₂, or ZnO by calculation;

FIG. 4 illustrates an X-ray diffraction pattern of a product powder of Example 4. The horizontal axis indicates a 2θ value (°), and the vertical axis indicates intensity (a.u.). 100 rpm, 200 rpm, 300 rpm, 400 rpm, or 500 rpm indicates the rotation speed of the planetary ball mill apparatus during production. RHO-type, ANA-type, or ZnO indicates a simulation result of an X-ray diffraction pattern of RHO-type Zn(2-EtIm)₂, ANA-type Zn(2-EtIm)₂, or ZnO by calculation;

FIG. 5 illustrates abundance ratios of RHO-type MOFs to the total weight of the products of Examples and Comparative Examples. The horizontal axis indicates the rotation speed (rpm) of the planetary ball mill apparatus during production, and the vertical axis indicates the abundance ratio (weight %) of the RHO-type MOF; and

FIG. 6 illustrates N₂ adsorption amounts determined by measuring N₂ adsorption/desorption isotherms of the products of Examples 1 to 4 and Comparative Examples 1 to 4. The horizontal axis indicates the rotation speed (rpm) of the planetary ball mill apparatus during production, and the vertical axis indicates the N₂ adsorption amount (mL (STP)·g⁻¹) at N₂ relative pressure of 50% determined by measuring the N₂ adsorption/desorption isotherm.

### DETAILED DESCRIPTION

The following describes embodiments of the present disclosure in detail.

### <1: Metal Organic Framework>

Another aspect of the present disclosure relates to a metal organic framework (MOF). The MOF of the aspect is made of metal ions as zinc (Zn) cations and ligands as 2-ethylimidazole (2-EtIm) or monocarboxylic acid anions, and has an RHO-type topology in which the 2-EtIm anions are partially substituted with the monocarboxylic acid anions.

The MOF of Zn(2-EtIm)₂ made of Zn and 2-EtIm may have various topologies. Among them, it is known that the MOF of Zn(2-EtIm)₂ having the RHO-type topology has a large pore capacity. It is also known that there is a constant correlation between the pore capacity and the gas adsorption property of the MOF. Therefore, the MOF of the aspect having the RHO-type topology can have a high gas adsorption property compared with MOFs having other topologies.

In the MOF of the aspect, the 2-EtIm anions are partially substituted with the monocarboxylic acid anions. The monocarboxylic acid may be benzoic acid, acetic acid, or formic acid, may be benzoic acid or acetic acid, and may be benzoic acid. A partial substitution of the 2-EtIm anions with the monocarboxylic acid anions allows a MOF having large pores to be obtained due to the template effect of the monocarboxylic acid. In particular, in the case of the monocarboxylic acid having a bulky group, such as benzoic acid, the template effect of the monocarboxylic acid is more pronounced, resulting in a MOF having larger pores.

In the MOF of the aspect, the abundance ratio of the monocarboxylic acid anions in the ligands to the total amount by mole of the ligands may be in a range from 1 to 20 mol %, may be in a range from 3 to 20 mol %, and may be in a range from 3 to 12 mol %. The abundance ratio of the monocarboxylic acid anions in the ligands within the above range allows the MOF of the aspect to have a high gas adsorption property.

The MOF of the aspect is usually represented by the following formula (I):

Zn(2-EtImₓMCA_{y})₂

In the formula (I), 2-EtIm is a ligand as a 2-ethylimidazole anion, and MCA is a ligand as a monocarboxylic acid anion. x may be in a range from 0.8 to 0.99, may be in a range from 0.8 to 0.97, and may be in a range from 0.88 to 0.97. y may be in a range from 0.01 to 0.2, may be in a range from 0.03 to 0.2, and may be in a range from 0.03 to 0.12. The MOF of the aspect represented by the formula (I) can have a high gas adsorption property.

The gas adsorption property of the MOF of the aspect can be evaluated, for example, by measuring an N₂ adsorption isotherm of the MOF and calculating an N₂ adsorption amount at N₂ relative pressure of 50%. The N₂ adsorption amount of the MOF of the aspect at the N₂ relative pressure of 50% is typically equal to or more than 180 mL (STP)·g⁻¹, and in particular, in a range from 180 to 410 mL (STP)·g⁻¹.

### <2: Method for Producing Metal Organic Framework>

Another aspect of the present disclosure relates to a method for producing the metal organic framework of one aspect of the present disclosure.

The method of the aspect includes a mechanochemical reaction step. The step includes causing a mechanochemical reaction between a zinc compound, 2-ethylimidazole (2-EtIm), and a monocarboxylic acid in the presence of a solvent. In the specification, the mechanochemical reaction refers to applying mechanical stress, such as pulverization, to a raw material to change the crystalline structure of the raw material and thus causing the chemical reaction to proceed.

The zinc compound used in this step may be zinc oxide or zinc hydroxide, and may be zinc oxide. The zinc compound exemplified above can be improved in reactivity by using a solvent exemplified below. Therefore, performing this step using the zinc compound exemplified above allows the mechanochemical reaction to efficiently proceed to obtain the MOF of one aspect of the present disclosure.

The monocarboxylic acid used in this step may be a compound exemplified above as a ligand. The presence of the monocarboxylic acid in the mechanochemical reaction system promotes the decomposition of the zinc compound as a raw material, while the decomposition of the MOF as a product is not promoted. Therefore, performing this step by adding the monocarboxylic acid exemplified above allows the MOF of one aspect of the present disclosure as a product to be obtained in high yields while promoting the decomposition of the zinc compound as a raw material.

The solvent used in this step may be a water-miscible organic solvent, may be N,N-dimethylformamide, methanol, N,N-diethylformamide, or ethanol, and may be N,N-dimethylformamide or methanol. The solvent exemplified above may dissolve 2-ethylimidazole (2-EtIm) and/or the monocarboxylic acid as raw materials. Therefore, performing this step using the solvent exemplified above allows the mechanochemical reaction to efficiently proceed to obtain the MOF of one aspect of the present disclosure.

In this step, the mechanochemical reaction may include mixing the raw materials using a ball mill. In this embodiment, a rotation speed of the ball mill may be 50 rpm or more, may be in a range from 50 to 800 rpm, and may be in a range from 100 to 500 rpm. A mixing time with the ball mill may be 1 hour or more, and may be in a range from 1 to 3 hours. Performing this step under the above conditions allows the mechanochemical reaction to efficiently proceed to obtain the MOF of one aspect of the present disclosure.

As described in detail above, the MOF of one aspect of the present disclosure has the RHO-type topology in which the 2-EtIm anions as ligands are partially substituted with the monocarboxylic acid anions, and thus can have a large pore capacity and a high gas adsorption property. Therefore, the MOF of one aspect of the present disclosure can be applied to a gas adsorption material in a gas adsorption system, a gas separation system, or a gas storage system. In addition, with the production method of one aspect of the present disclosure, the MOF of one aspect of the disclosure having the features described above can be obtained in high yields. Therefore, the production method of one aspect of the present disclosure can efficiently provide a material applicable to the applications exemplified above.

### Examples

The following describes the present disclosure in more detail with reference to examples. However, the technical scope of the present disclosure is not limited to these examples.

### I: Production of Metal Organic Framework

### I-1: Reagent

Zinc oxide (ZnO): FUJIFILM Wako Pure Chemical Corporation, 0.02 μm, Practical Grade, 95.0+%
2-ethylimidazole (2-EtIm): Tokyo Chemical Industry Co., Ltd., >98.0%
Benzoic acid (BA): FUJIFILM Wako Pure Chemical Corporation, 99.5+%
Acetic acid (AA): FUJIFILM Wako Pure Chemical Corporation, 99.7+%
Phosphoric acid (PA): FUJIFILM Wako Pure Chemical Corporation, 85.0+%
Methanol (MeOH): Nacalai Tesque, INC., Nacalai 1st Grade≥99.0%
Ethanol (EtOH): Kanto Chemical Co., Inc., Guaranteed Reagent, 94.8% to 95.8%
N,N-dimethylformamide (DMF): FUJIFILM Wako Pure Chemical Corporation, Super Dehydrated, for Organic Synthesis, 99.5+%

### I-2: Comparative Example 1-1

A raw material containing 1.22 g (15 mmol) of ZnO, 2.88 g (30 mmol) of 2-EtIm, and 3 mL of DMF, and 50 g of zirconia balls with φ 5 mm were added to a 45 mL ball mill vessel. The ball mill vessel was placed in a planetary ball mill apparatus. A rotation speed of the planetary ball mill apparatus was set to 100 rpm, and the mixture of the raw material was mixed by adding the rotation for 3 hours. The reaction mixture was collected and the zirconia balls were removed from the reaction mixture. 50 mL of ethanol was added to the reaction mixture and stirred. The reaction mixture was subjected to centrifugation at 16000 rpm for 15 minutes to remove a supernatant. The centrifugation and the supernatant removal were repeated four times in total. The collected precipitate was dried at 60° C. overnight while reducing pressure. A powder was obtained by the above process.

### I-3: Comparative Examples 1-2, 1-3, 1-4, 1-5

A powder of Comparative Example 1-2, 1-3, 1-4, or 1-5 was obtained similarly to Comparative Example 1-1, except that the rotation speed of the planetary ball mill apparatus was changed to 200, 300, 400, or 500 rpm.

### I-4: Comparative Example 2-1

A powder of Comparative Example 2-1 was obtained similarly to Comparative Example 1-1, except that the quantity of 2-EtIm was changed to 3.60 g (37.5 mmol).

### I-5: Comparative Examples 2-2, 2-3, 2-4, 2-5

A powder of Comparative Example 2-2, 2-3, 2-4, or 2-5 was obtained similarly to Comparative Example 2-1, except that the rotation speed of the planetary ball mill apparatus was changed to 200, 300, 400, or 500 rpm.

### I-6: Comparative Example 3-1

A powder of Comparative Example 3-1 was obtained similarly to Comparative Example 1-1, except that the quantity of DMF was changed to 6 mL.

### I-7: Comparative Examples 3-2, 3-3, 3-4, 3-5

A powder of Comparative Example 3-2, 3-3, 3-4, or 3-5 was obtained similarly to Comparative Example 3-1, except that the rotation speed of the planetary ball mill apparatus was changed to 200, 300, 400, or 500 rpm.

### I-8: Comparative Example 4-1

A powder of Comparative Example 4-1 was obtained similarly to Comparative Example 1-1, except that DMF was changed to 3 mL of MeOH.

### I-9: Comparative Examples 4-2, 4-3, 4-4, 4-5

A powder of Comparative Example 4-2, 4-3, 4-4, or 4-5 was obtained similarly to Comparative Example 4-1, except that the rotation speed of the planetary ball mill apparatus was changed to 200, 300, 400, or 500 rpm.

### I-10: Example 1-1

A powder of Example 1-1 was obtained similarly to Comparative Example 1-1, except that 0.916 g (7.5 mmol) of BA was added to the raw material.

### I-11: Examples 1-2, 1-3, 1-4, 1-5

A powder of Example 1-2, 1-3, 1-4, or 1-5 was obtained similarly to Example 1-1, except that the rotation speed of the planetary ball mill apparatus was changed to 200, 300, 400, or 500 rpm.

### I-12: Example 2-1

A powder of Example 2-1 was obtained similarly to Example 1-1, except that DMF was changed to 3 mL of MeOH.

### I-13: Examples 2-2, 2-3, 2-4, 2-5

A powder of Example 2-2, 2-3, 2-4, or 2-5 was obtained similarly to Example 2-1, except that the rotation speed of the planetary ball mill apparatus was changed to 200, 300, 400, or 500 rpm.

### I-14: Example 3-1

A powder of Example 3-1 was obtained similarly to Comparative Example 1-1, except that 0.450 g (7.5 mmol) of AA was added to the raw material.

### I-15: Examples 3-2, 3-3, 3-4, 3-5

A powder of Example 3-2, 3-3, 3-4, or 3-5 was obtained similarly to Example 3-1, except that the rotation speed of the planetary ball mill apparatus was changed to 200, 300, 400, or 500 rpm.

### I-16: Example 4-1

A powder of Example 4-1 was obtained similarly to Example 3-1, except that DMF was changed to 3 mL of MeOH.

### I-17: Examples 4-2, 4-3, 4-4, 4-5

A powder of Example 4-2, 4-3, 4-4, or 4-5 was obtained similarly to Example 4-1, except that the rotation speed of the planetary ball mill apparatus was changed to 200, 300, 400, or 500 rpm.

### I-18: Comparative Example 5-1

A powder of Comparative Example 5-1 was obtained similarly to Comparative Example 1-1, except that 0.865 g (7.5 mmol) of PA was added to the raw material.

### I-19: Comparative Examples 5-2, 5-3, 5-4, 5-5

A powder of Comparative Example 5-2, 5-3, 5-4, or 5-5 was obtained similarly to Comparative Example 5-1, except that the rotation speed of the planetary ball mill apparatus was changed to 200, 300, 400, or 500 rpm.

### I-20: Comparative Example 6-1

A powder of Comparative Example 6-1 was obtained similarly to Comparative Example 5-1, except that DMF was changed to 3 mL of MeOH.

### I-21: Comparative Examples 6-2, 6-3, 6-4, 6-5

A powder of Comparative Example 6-2, 6-3, 6-4, or 6-5 was obtained similarly to Example 6-1, except that the rotation speed of the planetary ball mill apparatus was changed to 200, 300, 400, or 500 rpm.

### II: Analysis of Crystalline Structure of Metal Organic Framework

The product powders obtained in Comparative Examples 1-1 to 6-5 and Examples 1-1 to 4-5 were each subjected to an X-ray diffraction measurement. The measurement device and the measurement condition are described below.
Measurement device: RINT RAPID II (Rigaku Corporation)
Measurement condition: Voltage 50 V, current 100 mA, collimator diameter φ 0.3, sample angle ω 5°

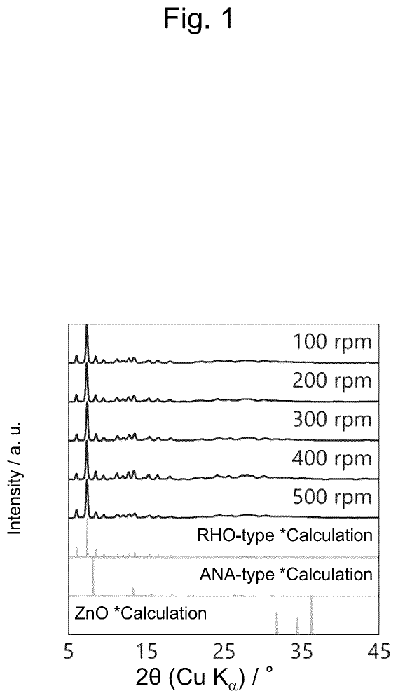

X-ray diffraction patterns of RHO-type Zn(2-EtIm)₂ (reported under the name of MAF-6) and ANA-type Zn(2-EtIm)₂ (reported under the name of MAF-5 or ZIF-14), which are the known MOFs, and ZnO as a raw material were simulated by calculation, and compared with X-ray diffraction patterns of the product powders of Comparative Examples and Examples. The X-ray diffraction patterns of the product powders of Examples 1, 2, 3 and 4 are shown in FIGS. 1, 2, 3 and 4, respectively. In each of the drawings, the horizontal axis indicates a 2θ value (°), and the vertical axis indicates intensity (a.u.). In each of the drawings, 100 rpm, 200 rpm, 300 rpm, 400 rpm, or 500 rpm indicates the rotation speed of the planetary ball mill apparatus during production. RHO-type, ANA-type, or ZnO indicates the simulation result of the X-ray diffraction pattern of RHO-type Zn(2-EtIm)₂, ANA-type Zn(2-EtIm)₂, or ZnO by calculation.

The X-ray diffraction pattern of the product powder of Comparative Example 1 has revealed that the product at 100 rpm was a mixture of ZnO as a raw material and the RHO-type MOF (the X-ray diffraction pattern is not shown). The peak intensity of ZnO in the X-ray diffraction pattern decreased as the rotation speed of the planetary ball mill apparatus during production increased. In view of this, it is presumed that a production amount of the MOF increases with an increase in the rotation speed of the planetary ball mill apparatus during production. On the other hand, when the rotation speed of the planetary ball mill apparatus during production increased to 200 rpm or more, the peak intensity of the ANA-type MOF in the X-ray diffraction pattern increased. From these results, it is presumed that the RHO-type MOF is mainly produced when the rotation speed of the planetary ball mill apparatus during production is low, but a production amount of the ANA-type MOF becomes greater than a production amount of the RHO-type MOF as the rotation speed increases. Similar tendencies were confirmed in the X-ray diffraction patterns of the product powders of Comparative Examples 2, 3 and 4 (the X-ray diffraction patterns are not shown).

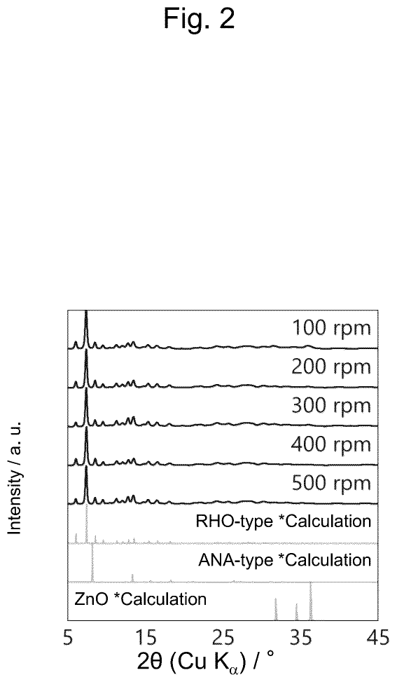

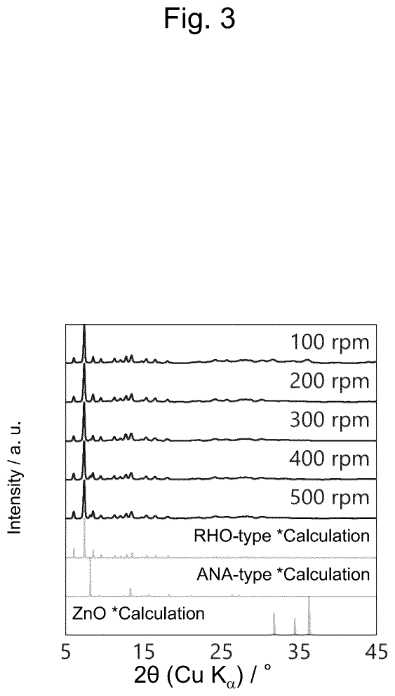

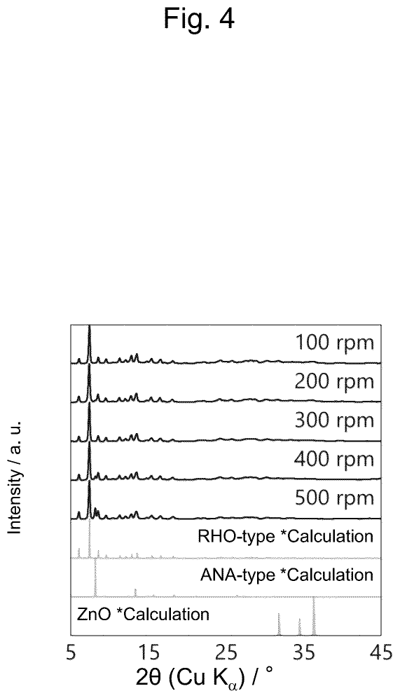

The X-ray diffraction pattern of the product powder of Example 1 has revealed that the product had a single phase of the RHO-type MOF irrespective of the rotation speed of the planetary ball mill apparatus during production (FIG. 1). In Example 2, while the presence of ZnO was observed to a minor extent in the product whose rotation speed of the planetary ball mill apparatus during production was 100 rpm or 300 rpm, the main phase was the RHO-type MOF (FIG. 2). In Example 3 and Example 4, the ANA-type MOFs were slightly produced with the increase in the rotation speed of the planetary ball mill apparatus during production (FIGS. 3 and 4).

In the X-ray diffraction pattern of the product powder of Comparative Example 5, peaks that are not attributed to RHO-type or ANA-type were observed (the X-ray diffraction pattern is not shown). In the X-ray diffraction pattern of the product powder of Comparative Example 6, in addition to the peaks observed in Comparative Example 5, peaks of the ANA-type MOF were observed to a small extent with the increase in the rotation speed of the planetary ball mill apparatus during production (the X-ray diffraction pattern is not shown). These results have revealed that while the addition of PA promotes the decomposition and the reaction of ZnO, the monocarboxylic acid such as BA and AA may be added for the production of the RHO-type MOF.

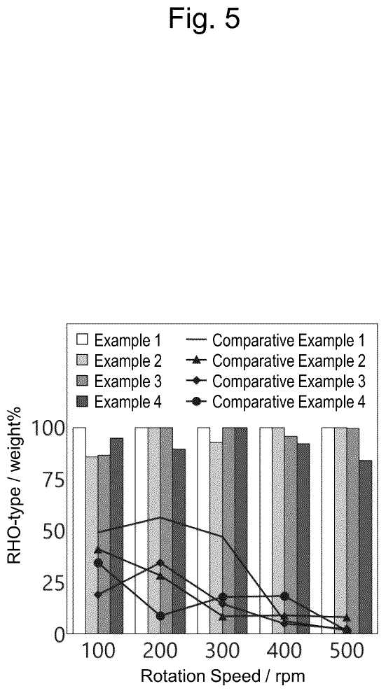

The abundance ratios of the RHO-type MOF, the ANA-type MOF, and ZnO as a raw material were calculated from the peak intensity in the X-ray diffraction patterns of the product powders of Examples and Comparative Examples. The abundance ratios of the RHO-type MOFs to the total weight of the products of Examples and Comparative Examples are shown in FIG. 5. In the drawing, the horizontal axis indicates the rotation speed (rpm) of the planetary ball mill apparatus during production, and the vertical axis indicates the abundance ratio (weight %) of the RHO-type MOF.

As illustrated in FIG. 5, in the products of Comparative Examples 1 to 4, while the abundance ratio of ZnO decreased with the increase in the rotation speed of the planetary ball mill apparatus during production, the production of the ANA-type MOF was advantageous, and thus the abundance ratio of the RHO-type MOF decreased. In contrast, in the products of Examples 1 to 4, the RHO-type MOF was obtained as the main phase under all conditions.

### III: Characterization of Metal Organic Framework

### III-1: Evaluation of Pore Capacity of MOF

The products of Examples 1 to 4 and Comparative Examples 1 to 4 were each pretreated, and then N₂ adsorption isotherms were measured. In addition, N₂ adsorption amounts at N₂ relative pressure of 50% were determined. The pretreatment device, the pretreatment condition, the measurement device, and the measurement condition used for the measurements are described below.
Pretreatment device: BELPREP vac II (MicrotracBEL Corp.)
Pretreatment condition: Heated at a degree of vacuum of <10⁻² Pa, at 160° C. for 6 hours
Measurement device: BELSORP max (MicrotracBEL Corp.)
Measurement condition: N₂ adsorption amount at a temperature of 77K and N₂ relative pressure of 0 to 99% is measured

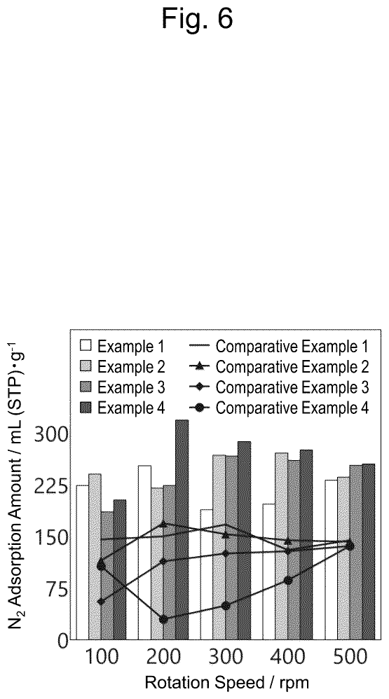

The N₂ adsorption amounts determined by measuring N₂ adsorption/desorption isotherms of the products of Examples 1 to 4 and Comparative Examples 1 to 4 are shown in FIG. 6. In the drawing, the horizontal axis indicates the rotation speed (rpm) of the planetary ball mill apparatus during production, and the vertical axis indicates the N₂ adsorption amount (mL (STP)·g⁻¹) at N₂ relative pressure of 50% determined by measuring the N₂ adsorption/desorption isotherm.

As illustrated in FIG. 6, it was confirmed that, compared with the products of Comparative Examples 1 to 4, the products of Examples 1 to 4 tended to have high N₂ adsorption amounts. In the products of Comparative Examples 1 to 4, while the product whose rotation speed of the planetary ball mill apparatus during production was 400 rpm or 500 rpm had a low abundance ratio of the RHO-type MOF (FIG. 5), the N₂ adsorption amount was not very low. The ANA-type MOF has a pore capacity of approximately ½ that of the RHO-type MOF. In view of this, it is presumed that when the ANA-type MOF is produced instead of the RHO-type MOF, a certain amount of N₂ adsorption is exhibited. From these results, it is presumed that the addition of the monocarboxylic acid (in particular, benzoic acid) promotes the decomposition of ZnO and the formation of the RHO-type MOF.

### III-2: Composition Analysis of MOF

The products of Examples 1 to 4 were decomposed and dissolved with a deuterated solvent. ¹H-NMR spectra of the obtained solutions were measured to obtain the ratios of 2-ethylimidazole and monocarboxylic acid (benzoic acid or acetic acid) contained in the MOF from the integration ratios of the spectra. The decomposition condition, the measurement device, and the measurement condition used for the measurements are described below.

Decomposition condition: A product is decomposed with heavy water (D₂O) solution of 10 weight % deuterated sulfuric acid (D₂SO₄)
Measurement device: INOVA 300 (Agilent Technologies)

Compositions of the RHO-type MOFs obtained from the ¹H-NMR spectra of the products of Examples 1 to 4 are shown in Table 1.

TABLE 1

| Example Number | Composition Formula of RHO-type MOF |
|---|---|
| Example 1-1 | Zn(2-EtIm_{0.91}BA_{0.09})₂ |
| Example 1-2 | Zn(2-EtIm_{0.91}BA_{0.09})₂ |
| Example 1-3 | Zn(2-EtIm_{0.92}BA_{0.08})₂ |
| Example 1-4 | Zn(2-EtIm_{0.92}BA_{0.08})₂ |
| Example 1-5 | Zn(2-EtIm_{0.91}BA_{0.09})₂ |
| Example 2-1 | Zn(2-EtIm_{0.93}BA_{0.07})₂ |
| Example 2-2 | Zn(2-EtIm_{0.89}BA_{0.11})₂ |
| Example 2-3 | Zn(2-EtIm_{0.88}BA_{0.12})₂ |
| Example 2-4 | Zn(2-EtIm_{0.88}BA_{0.12})₂ |
| Example 2-5 | Zn(2-EtIm_{0.92}BA_{0.08})₂ |
| Example 3-1 | Zn(2-EtIm_{0.96}AA_{0.04})₂ |
| Example 3-2 | Zn(2-EtIm_{0.96}AA_{0.04})₂ |
| Example 3-3 | — |
| Example 3-4 | — |
| Example 3-5 | — |
| Example 4-1 | Zn(2-EtIm_{0.96}AA_{0.04})₂ |
| Example 4-2 | Zn(2-EtIm_{0.97}AA_{0.03})₂ |
| Example 4-3 | — |
| Example 4-4 | — |
| Example 4-5 | — |

The monocarboxylic acid added at the time of synthesizing becomes negative monovalent organic anions. In view of this, it is presumed that the monocarboxylic acids were incorporated into the structure of the MOF in the form of a partial substitution for 2-ethylimidazoles.

The present disclosure is not limited to the above-described examples, and includes various modifications. For example, the above-described examples are described in detail for ease of understanding of the present disclosure, and are not necessarily limited to those having all of the described configurations. Addition, deletion, and/or replacement of another configuration can be performed on a part of the configuration in each of the examples.

What is claimed is:

1. A metal organic framework comprising:
metal ions as zinc cations; and
ligands as 2-ethylimidazole (2-EtIm) or monocarboxylic acid anions,
wherein the metal organic framework has an RHO-type topology in which the 2-EtIm anions are partially substituted with the monocarboxylic acid anions.

2. The metal organic framework according to claim 1,
wherein the monocarboxylic acid is benzoic acid or acetic acid.

3. The metal organic framework according to claim 1,
wherein an abundance ratio of the monocarboxylic acid anions in the ligands to a total amount by mole of the ligands is in a range from 1 to 20 mol %.

4. A method for producing the metal organic framework according to claim 1, comprising:
causing a mechanochemical reaction between a zinc compound, 2-ethylimidazole (2-EtIm), and a monocarboxylic acid in a presence of a solvent.

5. The method according to claim 4,
wherein the mechanochemical reaction includes mixing raw materials using a ball mill.
